(19) United States
(12) Patent Application Publication
(10) Pub. No.: US 2006/0044547 A1
(43) Pub. Date: Mar. 2, 2006

(54) Photonic crystal based optical doppler projectile detection system

(76) Inventor: Richard G. Hoffman II, Plano, TX (US)

Correspondence Address: BAKER BOTTS LLP, 2001 ROSS AVENUE, 6TH FLOOR, DALLAS, TX, 75201, US

(21) Appl. No.: 10/925,645

(22) Filed: Aug. 25, 2004

(51) Int. Cl. G01P 3/36

(52) U.S. Cl. 356/28; 356/28.5

(57) ABSTRACT

A method for use in sensing a moving object by doppler global sensing includes illuminating the object with energy, filtering energy reflected by the object with a frequency selective surface filter, and sensing the filtered energy. An associated system includes a laser operable to illuminate an object with energy and a frequency selective surface operable to filter energy reflected off the object. The system also includes a camera operable to receive energy reflected off the object that is passed by the frequency selective surface.

### TECHNICAL FIELD OF THE INVENTION

This invention relates generally to sensing of moving objects and more particularly to a method and system for use in sensing a moving object by a variant of the Doppler Global Velocimetry technique.

### BACKGROUND OF THE INVENTION

A continuing problem in tactical military operations is sensing incoming threat projectiles to determine defensive actions and possibly implement counter measures. One component of addressing this problem is utilizing the doppler shift of energy reflected from the moving projectile to find the object and separate it from the background. Such an approach also may be used to detect objects other than projectiles in military operations.

One way of sensing the doppler shifted energy reflected from a moving target that has been illuminated by a narrow waveband source is to use a type of optical frequency-to-intensity converter. These converters work by filtering the receiver of the reflected optical energy such that only the doppler shifted energy is sensed, while the source carrier frequency energy is blocked. It is generally desirable that the filter has a very narrow bandwidth to separate the carrier and doppler shifted wavelengths. When the velocity of the moving target is measured, this technique is referred to as Doppler Global Velocimetry (DGV), since the sensing can occur over the entire field-of-view of a camera at once.

Certain previous implementations of Doppler Global Velocimetry use a low pressure gas atomic or molecular filter that consists of a pressure vessel with windows at each end, filled with the correct gas mixture at a particular temperature and pressure. These filters are often relatively large and heavy and require stringent pressure, temperature, and leakage control. Consequently these filters are expensive from an initial and recurring cost standpoint and are not readily adapted to smaller, more compact sensor size requirements.

### SUMMARY OF THE INVENTION

A method for use in sensing a moving object by Doppler Global Velocimetry, with or without the measurement of the object velocity, includes illuminating the object with energy, filtering energy reflected by the object with a photonic crystal filter, and sensing the filtered energy. The simplest form of photonic crystal for this application is a frequency selective surface filter. An associated system includes a laser operable to illuminate an object with energy and a frequency selective surface filter operable to filter energy reflected off the object. The system also includes a camera operable to receive energy reflected off the object that is passed by the frequency selective surface.

Some embodiments of the invention provide numerous technical advantages. Some embodiments may benefit from some, none, or all of the below-described advantages. For example, according to one embodiment of the invention, a method and system for sensing a moving object by Doppler Global Velocimetry is provided that utilizes a filter that may be smaller than conventionally used filters. In addition, such filters may be more reliable and less susceptible to pressure changes than existing approaches. In addition, such filters may be made, in some embodiments, using integrated circuit manufacturing technology, providing many advantages associated with fabrication of integrated circuits, including economical fabrication. In addition, the filter may be located directly on a detector array as well as outside of a detecting camera.

Other advantages may be readily apparent to one of skill in the art.

### BRIEF DESCRIPTION OF THE FIGURES

Reference is now made to the following description taken in conjunction with the accompanying drawings, wherein like reference numbers represent like parts, in which:

FIG. 1 is block diagram illustrating a system for use in sensing moving objects by Doppler Global Velocimetry according to the teachings of the invention;

FIG. 2A is a schematic diagram of a frequency selective surface filter used in the system of FIG. 1 for receiving energy reflected from a moving object of FIG. 1; and

FIG. 2B is a graph illustrating the transmission characteristics of a frequency selective surface filter of FIG. 2A.

### DETAILED DESCRIPTION OF EXAMPLE EMBODIMENTS OF THE INVENTION

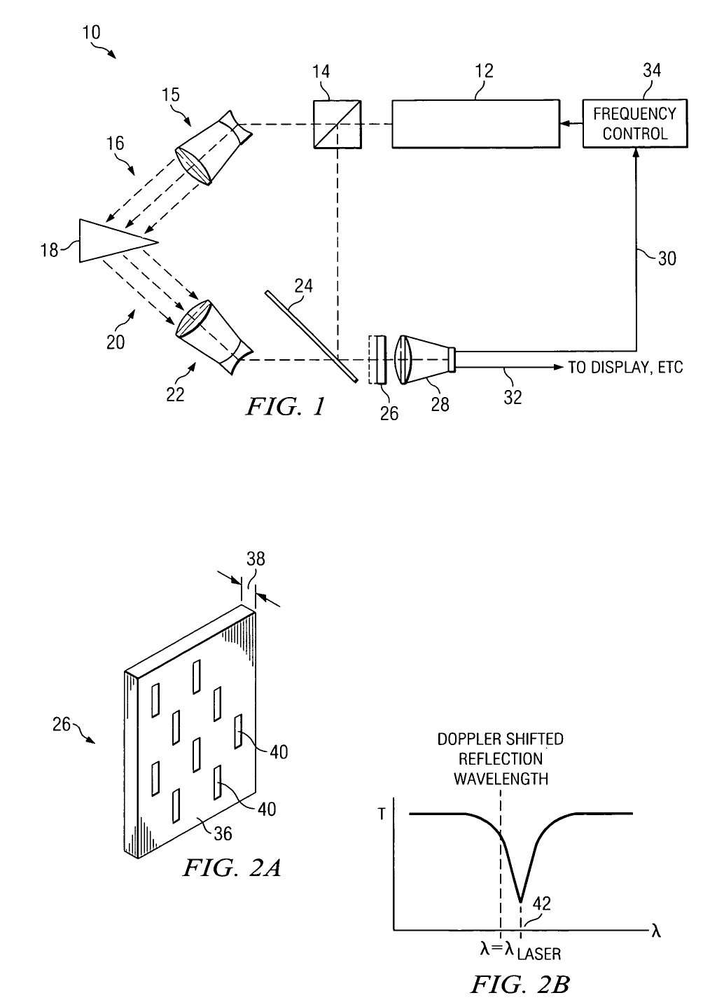

FIG. 1 illustrates a system 10 for use in sensing moving objects by Doppler Global Velocimetry. System 10 includes, in this embodiment, a laser 12 for generating optical energy, a beam splitter 14, an optical element 15 for directing energy from laser 12 in a desired direction, an optical element 22 for receiving energy reflected off of an object 18, a movable reflector 24, a frequency selective surface filter 26, a camera 28, and a frequency control unit 34.

Laser 12 generates energy substantially at a given wavelength for illuminating object 18. A portion of this energy may be selectively deflected by beam splitter 14 as described in greater detail below. This energy emitted from laser 12 is directed by optical element 15 towards moving object 18, as indicated by reference numeral 16. In response, energy 20 reflected off of moving object 18 is collected by optical element 22 and transmitted towards camera 28.

Prior to reaching camera 28, however, this energy is filtered by photonic crystal filter 26. A photonic crystal is a well-known term describing periodic dielectric or metallo-dielectric structure that is designed to affect the propagation of electromagnetic waves in a similar way to the way the periodic potential in a semiconductor crystal affects the electron motion by defining allowed and forbidden electronic energy bands. In this example, photonic crystal filter 26 is a frequency selective surface filter 26. According to the teachings of the invention, a frequency selective surface filter is utilized instead of conventional filters. The teachings of the invention recognize that a frequency selective surface filter is particularly suited to the present application because it may be designed to provide a maximum transmission of doppler shifted energy 20, while blocking substantially all of the laser carrier energy 16. This type of filter alleviates the cost, complexity, and fragility issues associated with other filter approaches described above.

Camera 28 collects the filtered reflected energy 20 and provides it over line 32 for processing. Camera 28 may be a charge-coupled device (CCD) camera conventionally used in Doppler Global Velocimetry or other suitable camera. As described above, Doppler Global Velocimetry involves determining a speed of a moving object based on a doppler shift between the wavelength of the illumination energy 16 and reflected energy 20. Such determination is well known in the art and is therefore not described in great detail herein. Camera 28 may also selectively provide a signal 30 to frequency controller 34 that is indicative of the amount of energy generated by laser 12 and split off by beam splitter 14 that is received directly by a camera 28, when the movable reflector 24 is positioned to reflect into the camera. This signal 30 would be selectively provided to determine whether frequency selective surface filter 26 is filtering out the energy from the laser. If not, the wavelength of the laser is adjusted.

As described above, it is desirable that frequency selective surface filter 26 substantially prevent all of illumination energy 16 from being received by camera 28, but allow substantially all of reflected energy 20 to be received by camera 28 in order to provide the greatest possible amount of energy from which the doppler shift can be determined. In this regard, frequency controller 34 is provided to control the frequency at which laser 12 emits light such that this frequency corresponds to the transmission characteristics of frequency selective surface 26. This may be effected, in one embodiment, by either periodically or occasionally splitting a portion of the illuminated energy 16 by beam splitter 14 and reflecting it by movable reflector 24 through frequency selective filter 26 to filter camera 28. During this procedure, no illumination energy is received from the moving object 18, in one embodiment. In response, signal 30, which is indicative of the amount of energy that is transmitted through frequency selective filter 26, is provided to frequency controller 34. In the event no energy is received in this example, frequency controller 34 makes no adjustment to the frequency of laser 12, because the wavelength at which laser 12 is generating energy matches the wavelength at which the frequency selective surface blocks all energy. Thus, in such a case the laser is operating at the desired wavelength. In the case where signal 30 indicates a threshold amount of energy is being transmitted by frequency selective filter 26, frequency controller 34 appropriately adjusts the wavelength of laser 12 until signal 30 indicates no energy is being transmitted through frequency selective surface 26.

FIG. 2A is a schematic diagram of one example of a frequency selective surface filter 26. Frequency selective surface filters are surface constructions designed as a filter for electromagnetic waves. As used herein, frequency selective surface filters are intended to encompass both two-dimensional frequency selective surfaces as well as frequency selective volumes, all being part of the technology referred to as photonic crystals. Frequency selective volumes may take a substantially three-dimensional form whereas a frequency selective surface sometimes colloquially refers to a substantially two-dimensional form, being generally flat. However, as used herein, frequency selective surface is meant to encompass both the two-dimensional and three-dimensional variety of such filters. Examples of frequency selective surfaces are contained in the following U.S. Patents, which are incorporated herein by reference: U.S. Pat. No. 6,208,316; U.S. Pat. No. 6,218,978; and U.S. Pat. No. 6,232,931. This type of filter is used because the bandpass can be made much smaller than ordinary filter approaches, while achieving the stated advantages over gas filters.

In this example, frequency selective surface filter 26 is formed from a substrate 36 having a plurality of apertures in a metal layer coated on a dielectric 40. In this example, substrate 36 is relatively thin having a thickness 38 and is thus referred to herein as two-dimensional; however, frequency selective surfaces according to the teachings of the invention may have a thickness that is substantial in comparison to its length and width. In addition, frequency selective surface filters can be constructed of multiple dielectric materials with suitable periodic features such as mesas.

As energy passes through apertures 40 of frequency selective surface 26, only particular wavelengths of energy are passed. Design of frequency selective surfaces is well known by those skilled in the art and can be designed to pass particular frequencies. Frequency selective surface filter 26 can be manufactured using techniques developed for nanotechnology applications. In some instances, aperture sizes 40 are comparable to those used in DVDs. Thus, the filter is a compact optical device easily incorporated into an optical system and can be used directly on a detector array associated with camera 28 or may be used outside camera 28, as illustrated in FIG. 1.

Any temperature sensitivity in frequency selective filter 26 can be compensated for in the sensor design by techniques well-known to those skilled in the art. One of these methods is described in lines 5 through 10. In addition, there is no significant pressure sensitivity and no leakage control concerns, as with certain other filters. Integrated circuit fabrication technology can be used to reduce the manufacturing costs, resulting in an economical alternative to the gas cell filter of prior systems.

FIG. 2B is a graph showing a desirable transmission characteristic for frequency selective surface filter 26. The graph of FIG. 2B illustrates transmission intensity versus wavelength. Point 42 of the graph illustrates a wavelength corresponding to the wavelength of the energy 16 produced by laser 12. Thus, frequency selective surface 26 will effectively block transmission of wavelengths near the wavelength of energy 16 produced by laser 12 and will transmit all other wavelengths. In this manner, the illumination energy 12 may be distinguished from the reflected energy 20, allowing determination of the doppler shift associated with moving object 18.

Although the present invention and its advantages have been described in detail, it should be understood that various changes, substitutions, and alterations can be made therein without departing from the spirit and scope of the invention as defined by the appended claims.

What is claimed is:

1. A system for use in sensing a moving object by doppler global sensing comprising:
a laser operable to illuminate an object with energy having a wavelength;
a frequency selective surface filter comprising a substrate formed with a plurality of apertures that prevents passage of energy at frequencies near a predetermined frequency and allows energy at other frequencies to pass;
a camera operable to receive energy reflected off the object that is passed by the frequency selective surface filter;
a controller operable to control the wavelength of energy illuminating the object in response to a signal indicative of the amount of energy being passed by the frequency selective surface filter; and
a processor operable to determine the presence of the moving object in response to a measure of doppler wavelength shift between the energy illuminating the object and energy reflected off the object that is passed by the frequency selective surface filter.

2. A method for use in sensing a moving object by doppler global sensing comprising:
illuminating the object with energy;
filtering energy reflected by the object by a photonic crystal filter; and
sensing the filtered energy.

3. The method of claim 2, wherein the photonic crystal filter comprises a substrate formed with a plurality of apertures.

4. The method of claim 2, wherein the photonic crystal filter prevents the passage of energy at frequencies near a predetermined frequency and allows energy at other frequencies to pass.

5. The method of claim 2, wherein the photonic crystal filter is one of substantially two-dimensional and substantially three-dimensional.

6. The method of claim 2, and further comprising detecting a moving object based on a shift of wavelength between the energy illuminating the object and the sensed filtered energy.

7. The method of claim 2, and further comprising controlling a wavelength of the energy illuminating the object such that the photonic crystal filter does not permit transmission of the energy illuminating the object at the wavelength.

8. The method of claim 7, wherein illuminating the object with a laser comprises illuminating the object with energy by a laser beam.

9. The method of claim 8, wherein controlling a wavelength of energy illuminating the object comprises splitting the laser beam, providing a portion of the split laser beam to the frequency selective surface filter, and filtering the portion of the split laser beam by the photonic crystal filter to generate a test signal.

10. The method of claim 9, wherein providing a portion of the split laser beam to the photonic crystal filter comprises providing the portion by a removable reflector.

11. The method of claim 8, and further comprising receiving the filtered signal by a camera.

12. The method of claim 11, wherein controlling the wavelength of the energy illuminating the object further comprises providing a signal indicative of the filtered signal to a controller operable to control a frequency of the energy illuminating the object.

13. The method of claim 12, wherein providing a signal indicative of the filtered signal comprises providing by the camera a signal indicative of the filtered signal.

14. A system for use in sensing a moving object by doppler global sensing comprising:
a laser operable to illuminate an object with energy;
a frequency selective surface filter operable to filter energy reflected off the object; and
a camera operable to receive energy reflected off the object that is passed by the frequency selective surface filter.

15. The system of claim 14, wherein the frequency selective surface filter comprises a substrate formed with a plurality of apertures.

16. The system of claim 14, wherein the frequency selective surface filter prevents the passage of energy at frequencies near a predetermined frequency and allows energy at other frequencies to pass.

17. The system of claim 14, wherein the frequency selective surface filter is one of substantially two-dimensional and substantially three-dimensional.

18. The system of claim 14, and further comprising a controller operable to control the wavelength of the energy in response to a signal indicative of the amount of energy that is passed by the frequency selective surface filter.
